(19) United States
(12) Patent Application Publication
(10) Pub. No.: US 2004/0007103 A1
(43) Pub. Date: Jan. 15, 2004

(54) HANDLE FOR HAND TOOL

(76) Inventor: Chih-Ching Hsien, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/193,118

(22) Filed: Jul. 12, 2002

(51) Int. Cl. B25G 1/01

(52) U.S. Cl. 81/489

(57) ABSTRACT

A hand tool includes a handle and a shank extends from a first end of the handle. A plurality of recesses are defined in an outer surface of the handle and located close to the first end of the handle so that the thumb of the user may put in one of the recesses. A plurality of ridges extend from an outside of the handle.

### FIELD OF THE INVENTION

The present invention relates to a handle of a hand tool and the handle has a plurality of recesses for receiving the thumb of the hand and a plurality of ridges extending from the surface of the handle so as to increase the friction.

### BACKGROUND OF THE INVENTION

A conventional hand tool is shown in FIG. 1 and generally includes handle 10 and a shank 11 extending from the handle 10. The handle 10 is suitable for being held by hand of the user and generally is a tubular bar. The handle 10 has a smooth surface and is not convenient for the user to hold the handle 10 tightly. When rotating the hand tool, the friction between the handle 10 and the hand of the user is critical for output a torque. When grease or sweat attached on the handle 10 or the hand of the user, the hand tends to be slippery.

The present invention intends to provide a handle of a hand tool wherein the handle has recesses for the thumb to be rested such that the handle is more securely held by the hand and the friction between the handle and the hand is high enough to output a high torque.

### SUMMARY OF THE INVENTION

In accordance with one aspect of the present invention, there is provided a hand tool which comprises a handle with a shank extending from a first end of the handle. A plurality of recesses are defined in an outer surface of the handle and located close to the first end of the handle.

The primary object of the present invention is to provide a handle of a hand tool wherein the handle is able to be securely held by the user.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the conventional hand tool;

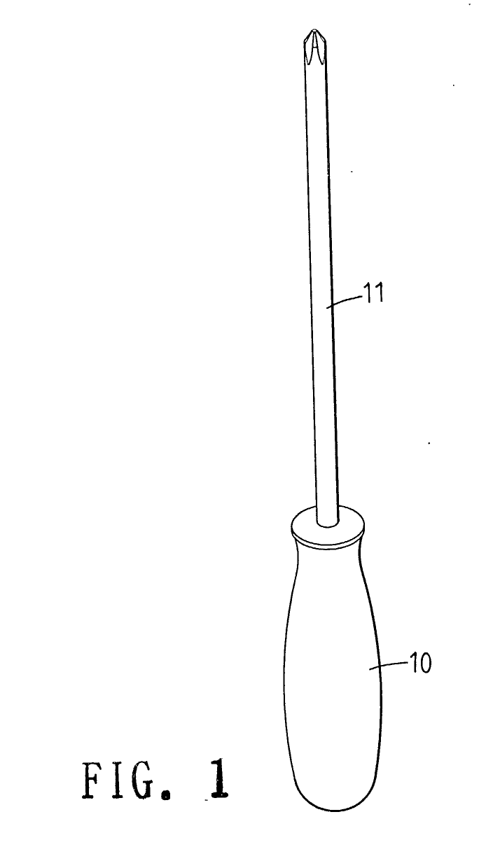

FIG. 2 is a perspective view to show the hand tool of the present invention;

FIG. 3 shows the thumb of the user put in the recess of the handle of the present invention;

FIG. 4 is a perspective view to show that the recess of the handle of the present invention has an extension wall; and

FIG. 5 shows the hand of the user holding the handle of the present invention.

### DETAILED DESCRIPTION OF THE PREFERRED EMBODIMENT

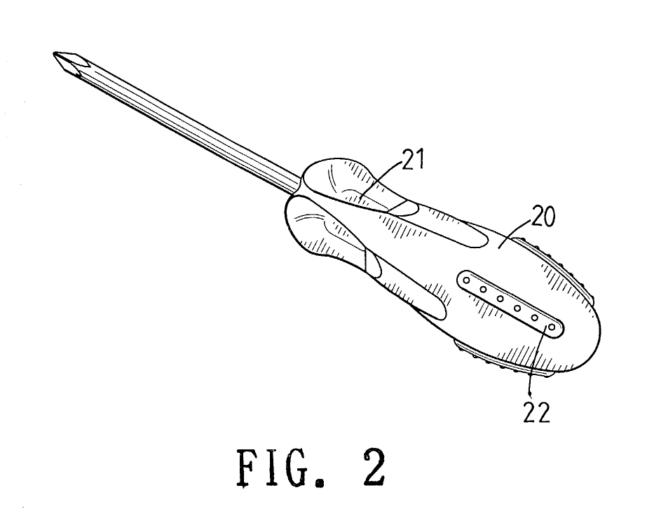

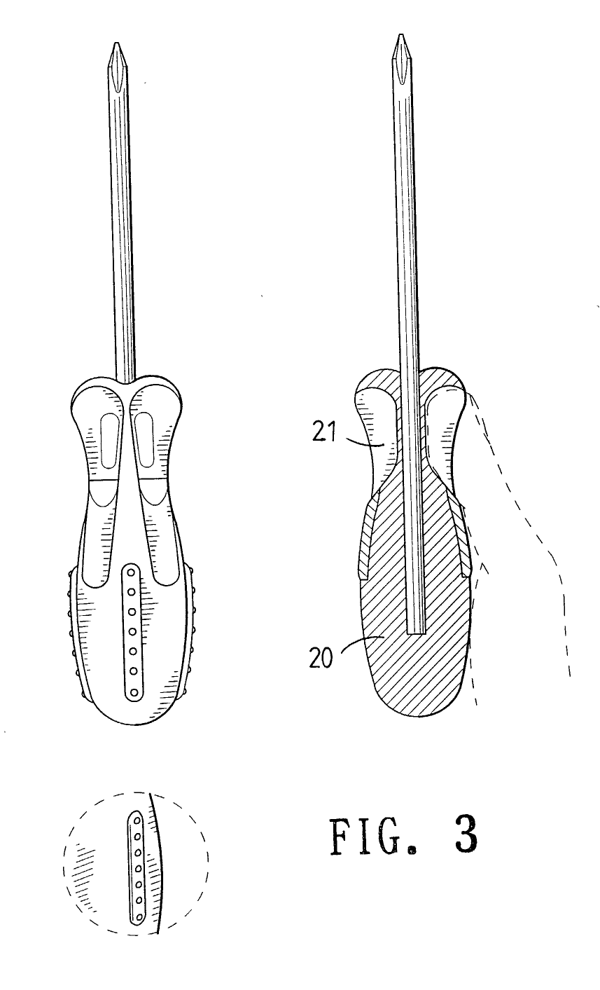

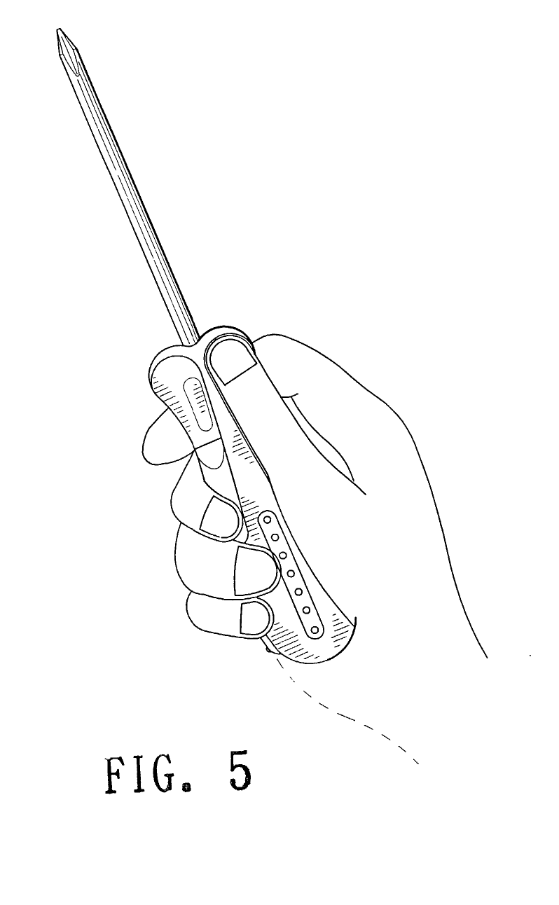

Referring to FIGS. 2, 3 and 5, the hand tool of the present invention comprises a handle 20 and a shank extends from a first end of the handle 20. A plurality of recesses 21 are defined in an outer surface of the handle 20 and located close to the first end of the handle 20. A plurality of ridges 22 extend from an outside of the handle 20 and each ridge 20 has a plurality of bosses extending therefrom.

When holding the handle 20, the thumb of the user's hand is placed in one of the recesses 21 and the thumb assists the rotation of the handle 20 to output a large torque.

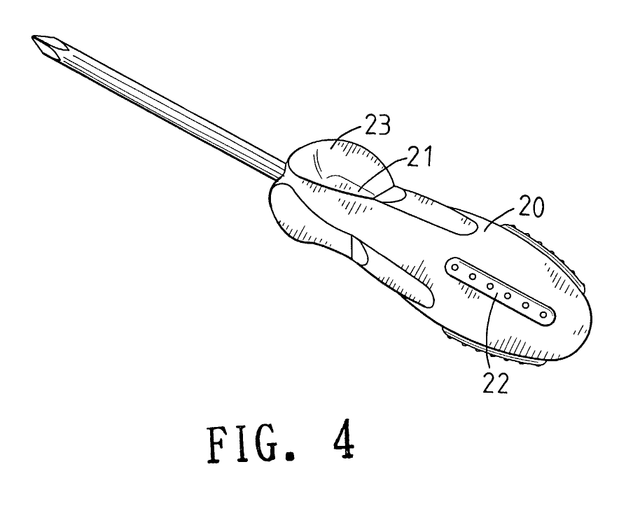

Referring to FIG. 4, an extension wall 23 extends from an inside of each of the recesses 21 and this ensures that the thumb is enclosed by the inside of the recess 21 such that the thumb will not slip off from the recess 21 during operation.

While we have shown and described the embodiment in accordance with the present invention, it should be clear to those skilled in the art that further embodiments may be made without departing from the scope of the present invention.

What is claimed is:

1. A hand tool comprising:
a handle having a shank extending from a first end of the handle, a plurality of recesses defined in an outer surface of the handle and located close to the first end of the handle.

2. The hand tool as claimed in claim 1, wherein an extension wall extends from an inside of each of the recesses.

3. The hand tool as claimed in claim 1, wherein a plurality of ridges extending from an outside of the handle.
